(19) United States
(12) Patent Application Publication
(10) Pub. No.: US 2007/0087587 A1
(43) Pub. Date: Apr. 19, 2007

(54) Method for manufacturing circuit board for semiconductor package

(76) Inventors: Ming Yeh Chang, Hsin-chu (TW); E-Tung Chou, Hsin-chu (TW); Che-Wei Hsu, Hsin-Chu (TW); Tzu-Sheng Tseng, Hsin-chu (TW)

Correspondence Address: Mr. Joseph A. Sawyer, Jr.;SAWYER LAW GROUP LLP, Suite 406, 2465 East Bayshore Road, Palo Alto, CA, 94303, US

(21) Appl. No.: 11/543,679

(22) Filed: Oct. 4, 2006

(30) Foreign Application Priority Data
Oct. 13, 2005 (TW) 094135633

(51) Int. Cl. H01R 12/00

(52) U.S. Cl. 439/66

(57) ABSTRACT

A method for manufacturing a circuit board for a semiconductor package is proposed. The method includes providing a circuit board having a circuit layer formed on at least one surface thereof, wherein the circuit board is defined with at least one predetermined area, the circuit layer includes a plurality of electrically conductive pads and conductive wires for electroplating and being connected with the electrically conductive pads, the conductive wires are formed within the predetermined area, and a metal protecting layer formed to cover the electrically conductive pads and the conductive wires; removing the portion of the metal protecting layer and the conductive wires covered by the portion of the metal protecting layer to electrically disconnect the electrically conductive pads from the conductive wires; and removing the predetermined area to form a through hole in the circuit board. Thus, formation of burrs in the metal protecting layer can be prevented after formation of the through hole.

### CROSS-REFERENCE TO RELATED APPLICATION

This application claims benefit under 35 USC 119 to Taiwan Application No. 094135633, filed Oct. 13, 2006.

### FIELD OF THE INVENTION

The present invention relates to methods for manufacturing a circuit board for a semiconductor package, and more particularly, to a method for manufacturing a window ball grid array (window BGA) circuit board for a semiconductor package.

### BACKGROUND OF THE INVENTION

A conventional Ball Grid Array (BGA) package basically includes: a semiconductor chip mounted on a circuit board, and a plurality of solder balls arranged in an array pattern implanted on the underside of the circuit board. A typical BGA package can thus meets the needs of high-integration semiconductor chips, as it contains more I/O connections than its predecessor such as lead frame does for the same area. Furthermore, with solder balls, the whole package unit is soldered together and electrically connected to an external printed circuit board.

Window BGA packaging is in line with the trend toward miniaturization of electronic products, because it allows for a reduction in the package size of BGA package products. The characteristics of a window BGA package are as follows. First, at least one through hole is disposed in the circuit board. Second, a semiconductor chip is mounted on a surface of the circuit board and one end of the through hole is sealed. And further, bonding wires (gold wires) passing through the through hole electrically connect the semiconductor chip and the electrically conductive pads on the other surface of the circuit board. Normally, a nickel/gold (Ni/Au) layer is formed on the exposed surfaces of the electrically conductive pads for two reasons, namely improving the electrical connection between the electrically conductive pads and the bonding wires, and preventing oxidation of the electrically conductive pads (typically oxidation of copper) caused by environmental effect. The electrically conductive pads may appear in the form of the bonding fingers of the circuit board for a semiconductor package, for example. The exposed surfaces of the electrically conductive pads are coated with a nickel/gold layer such that, during the subsequent wire-bonding process, the adherence of electrical connection between the bonding wires (gold wires) and the electrically conductive pads of the circuit board is improved as both of them comprise the same metal and thereby bond better.

The aforesaid nickel/gold protecting layer is usually formed on the electrically conductive pads by an electroplating process. Accordingly, the package circuit board should be provided therein with a plurality of conductive wires for electroplating and connected to the electrically conductive pads such that, during the electroplating process, the conductive wires collectively function as a current conduction path to allow the nickel/gold protecting layer to be electroplated on the electrically conductive pads. After the electroplating process for forming the nickel/gold protecting layer is completed, and then fabricating the routing process to form the through hole in the circuit board and cut electrical connection between the conductive wires and the electrically conductive pads.

FIGS. 1A to 1C are flow diagrams showing a conventional method for forming a through hole in a window BGA package circuit board on which a nickel/gold electroplating process has been performed.

Referring to FIGS. 1A and 1B, a circuit board 1 with a circuit layer 11 on at least one surface thereof is provided. The circuit board 1, on which a pre-stage circuit fabricating process has been performed, comprises at least one predetermined area S (as shown in FIG. 1B) used for subsequent formation of a through hole. The circuit layer 11 comprises a plurality of electrically conductive pads 110 and conductive wires 111 for electroplating and connected to the electrically conductive pads 110. Both the electrically conductive pads 110 and the conductive wires 111 are coated with a metal protecting layer 112. A solder mask layer 113 is further applied to the circuit board 1, and is formed with an opening 113a to expose the electrically conductive pads 110 and the conductive wires 111 that are coated with the metal protecting layer 112.

Referring to FIG. 1C, a routing process using a milling cutter is carried out, wherein the milling cutter cuts the circuit board 1 along the periphery of the predetermined area S so as to perform the following: first, severing the electrical connection between the conductive wires 111 and the electrically conductive pads 110 and thereby disconnecting therebetween, and; second, removing the predetermined area S so as to form a through hole 12 in the circuit board. Accordingly, a window BGA package circuit board 1′ is fabricated.

Since both the conductive wires 111 and the metal protecting layer 112 are made of ductile materials, when the milling cutter is cutting the circuit board to form the through hole 12, the ductile materials of the metal protecting layer 112 would be undesirably pulled by the milling cutter, resulting in the formation of burrs (b) at the periphery of the through hole 12 of the window BGA package circuit board, as shown in FIG. 1C.

Special milling cutters are used for cutting burrs during a routing process in attempts to solve the aforesaid problem with burrs, but they are so inefficient that the burr problem remains unsolved. Dedicated milling cutters of this type are so expensive that the aforesaid fabricated process incurs high costs and suffers from cost-inefficiency. Furthermore, the fabrication yields and throughput are low, because of the ineffective routing process and failure to effectively reduce a pitch between cavities of adjacent circuit boards.

Therefore, the problem to be solved here is to provide a method for manufacturing a circuit board for a semiconductor package so as to eliminate the problem with burrs caused by using a miller cutter to cut conductive wires, and overcome the drawbacks of increased costs, reduced yields and low throughput as in the foregoing prior art.

### SUMMARY OF THE INVENTION

In light of the drawbacks of the aforementioned prior art, it is a primary objective of the present invention to provide a method for manufacturing a circuit board for a semiconductor package whereby products are free from burrs.

Another objective of the present invention is to provide a method for manufacturing a circuit board for a semiconductor package whereby manufacturing costs are reduced.

Yet another objective of the present invention is to provide a method for manufacturing a circuit board for a semiconductor package whereby yields and throughput are increased.

In order to achieve the above and other objectives, the present invention provides a method for manufacturing a circuit board for a semiconductor package, comprising the following steps: providing a circuit board having a circuit layer formed on at least one surface thereof, wherein the circuit board comprises at least one predetermined area intended for subsequent formation of a through hole, the circuit layer comprises a plurality of electrically conductive pads and conductive wires for electroplating and connected with the electrically conductive pads, the conductive wires are formed within the predetermined area, and a metal protecting layer overlays both the electrically conductive pads and the conductive wires; removing portions of the metal protecting layer and portions of the conductive wires covered by the metal protecting layer, so as to disconnect the electrically conductive pads and the conductive wires; and removing the predetermined area so as to form the through hole in the circuit board.

In the present invention, both the portions of the metal protecting layer and the portions of the conductive wires covered by the metal protecting layer are removed using laser.

The aforesaid method for manufacturing a circuit board for a semiconductor package involves removing the predetermined area by using a machine cutter, so as to form the through hole in the circuit board.

Compared with the prior art, the method for manufacturing a circuit board for a semiconductor package according to the present invention involves cutting both the conductive wires within the predetermined area and the electrically conductive pads, disconnecting the electrically conductive pads and the conductive wires, cutting and removing the predetermined area with a machine cutter like a milling cutter, and eventually forming a through hole in the circuit board. Accordingly, the present invention absolves the machine cutter from cutting the ductile conductive wires and the metal protecting layer, such that burrs are unlikely to be formed at the periphery of the through hole as a result of the cutting of the ductile metal protecting layer with the machine cutter, thereby improving the fabrication yields and throughput.

The routing process is performed using an ordinary milling cutter directly according to the present invention, so as to form the through hole within the predetermined area, thereby reducing manufacturing costs and making the fabrication process cost-efficient. Hence, the present invention overcomes drawbacks of the foregoing prior art, namely high costs and cost inefficiency in performing the routing process using an expensive dedicated milling cutter, and the seemingly unavoidable formation of burrs.

### BRIEF DESCRIPTION OF THE DRAWINGS

FIGS. 1A to 1C are flow diagrams illustrating a conventional method for manufacturing a window BGA package circuit board; and

FIGS. 2A to 2E are flow diagrams illustrating a method for manufacturing a circuit board for a semiconductor package according to the present invention.

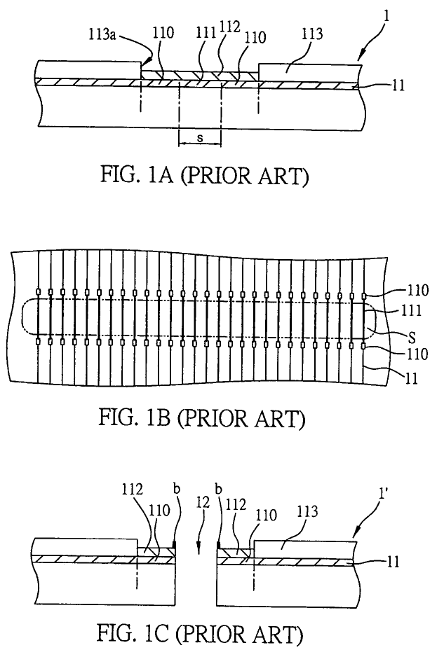

### DETAILED DESCRIPTION OF THE PREFERRED EMBODIMENTS

The following specific embodiment is provided to illustrate the present invention. Others skilled in the art can readily gain an insight into other advantages and features of the present invention based on the contents disclosed in this specification. The present invention can also be performed or applied in accordance with other different embodiments. Various modifications and changes based on different viewpoints and applications yet still within the scope of the present invention can be made in the details of the specification.

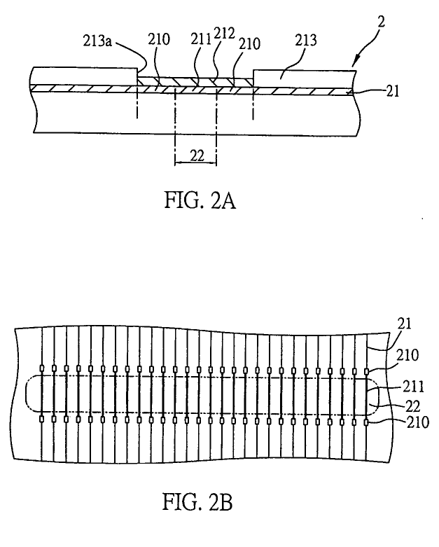

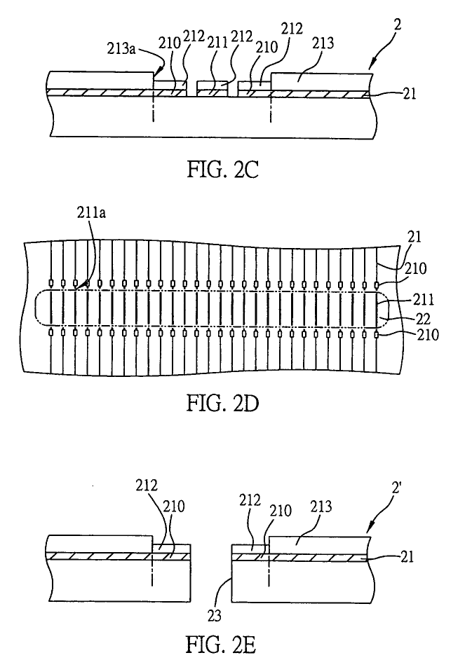

FIGS. 2A to 2E are flow diagrams illustrating a method for manufacturing a circuit board for a semiconductor package according to the present invention. It should be noted that the drawings are simplified schematic diagrams and only show components relating to the present invention. In practice, the layout of the components may be more intricate.

As shown in FIGS. 2A and 2B, a circuit board 2 with a circuit layer 21 disposed on at least one surface thereof is provided, and then a solder mask layer 213 is further formed on the circuit board 2 and an opening 213a in the solder mask layer 213 to expose the electrically conductive pads 210 and the conductive wires 211. The circuit board 2 is defined with at least one predetermined area 22 used for subsequent formation of a through hole. The circuit layer 21 comprises a plurality of electrically conductive pads 210 and the conductive wires 211 for electroplating and connected thereto. A metal protecting layer 212 is formed on both the electrically conductive pads 210 and the conductive wires 211. As shown in FIG. 2B, the circuit layer 21 comprises a plurality of electrically conductive pads 210 and the conductive wires 211 connected thereto, and the conductive wires 211 are formed within the predetermined area 22 so as to be connected to the electrically conductive pads 210. The circuit layer 21 is a patterned metallic copper layer. The metal protecting layer 212 may be made of a metal selected from the group consisting of lead, tin, silver, copper, gold, bismuth, antimony, zinc, nickel, zirconium, magnesium, indium, tellurium, and gallium, or made of an alloy composed of any metals selected from the aforesaid group. The metal protecting layer may alternatively comprise multiple layers, each of which may be made of a metal selected from the group consisting of lead, tin, silver, copper, gold, bismuth, antimony, zinc, nickel, zirconium, magnesium, indium, tellurium, and gallium.

Referring to FIGS. 2C and 2D, portions of the metal protecting layer 212 and portions of the conductive wires 211 covered by the metal protecting layer are cut by laser so as to form breakpoints 211a (as shown in FIG. 2D) between the electrically conductive pads 210 and the conductive wires 211, and then a through hole is formed in the circuit board 2, using an ordinary milling cutter.

Referring to FIG. 2E, a routing process is carried out to the circuit board 2 so as to remove the predetermined area 22 and form a through hole 23 in the circuit board 2. In this embodiment, in order to fabricate a circuit board for a semiconductor package 2′ having the through hole 23, a shaping tool, such as the milling cutter, is employed to cut the circuit board 2 along the periphery of the predetermined area 22 so as to perform the following: first, separating the predetermined area 22 from the circuit board 2 and then removing the predetermined area 22; second, forming the through hole 23 in the circuit board 2. In this embodiment, the circuit board 2 is directly cut along the inner periphery of the predetermined area 22 by the milling cutter, but no burrs are formed at the outer periphery (to be precise, mostly limited to the metal protecting layer 212 overlaying the electrically conductive pads 210) of the through hole 23 of the circuit board 2, because the electrical connection between the electrically conductive pads 210 and the conductive wires 11 is previously severed by laser.

Afterward, at least one semiconductor chip is mounted on and thereby integrated into the circuit board for a semiconductor package 2′, such that the active surface of the chip is firmly affixed to the circuit board for a semiconductor package 2′, using an adhesive. A plurality of bonding wires pass through the through hole of the package circuit board to electrically connect the semiconductor chip and the electrically conductive pads on the package circuit board. Then, both the semiconductor chip and the bonding wires are encapsulated with an encapsulant. Lastly, a plurality of solder balls are implanted on the surface of the package circuit board having the electrically conductive pads, such that the semiconductor chip can be electrically connected to external circuits by the solder balls.

Compared with the prior art, the method for manufacturing a circuit board for a semiconductor package according to the present invention involves disconnecting the electrically conductive pads and the conductive wires within the predetermined area by laser cutting, so as to turn the conductive wires within the predetermined area into independent circuits; this facilitates the formation of the through hole in the circuit board after directly cutting the circuit board along the inner periphery of the predetermined area and removing the predetermined area by the milling cutter. The present invention absolves the milling cutter from cutting any ductile conductive wires and metal protecting layer and thereby prevents the formation of burrs on the ductile metal protecting layer in the course of the cutting by the milling cutter. Therefore, the present invention increases the fabrication yields.

The routing process is performed using an ordinary milling cutter directly according to the present invention, so as to form the through hole within the predetermined area, thereby reducing manufacturing costs and making the fabrication process cost-efficient. Hence, the present invention overcomes drawbacks of the foregoing prior art, namely high costs and cost inefficiency in performing the routing process using an expensive dedicated milling cutter, and the seemingly unavoidable formation of burrs.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangement.

What is claimed is:

1. A method for manufacturing a circuit board for a semiconductor package, comprising the steps of:
providing a circuit board having a circuit layer formed on at least one surface thereof, wherein on the circuit board there is defined with at least one predetermined area, the circuit layer comprises a plurality of electrically conductive pads and conductive wires for electroplating and connected with the electrically conductive pads, the conductive wires are formed within the predetermined area, and a metal protecting layer is formed over the electrically conductive pads and the conductive wires;
removing a portion of the metal protecting layer and the conductive wires covered by the portion of the metal protecting layer to electrically disconnect the electrically conductive pads from the conductive wires; and
removing a portion of the circuit board defining the predetermined area to form a through hole penetrating through the circuit board.

2. The method for manufacturing a circuit board for a semiconductor package of claim 1, further comprising forming a solder mask layer on the surface of the circuit board having the circuit layer formed thereon, and forming an opening in the solder mask layer to expose the electrically conductive pads and the conductive wires.

3. The method for manufacturing a circuit board for a semiconductor package of claim 1, wherein the through hole of the circuit board is formed by cutting and removing the predetermined area with a cutting apparatus.

4. The method for manufacturing a circuit board for a semiconductor package of claim 3, wherein the cutting apparatus is a milling cutter.

5. The method for manufacturing a circuit board for a semiconductor package of claim 1, wherein the circuit layer is a patterned copper layer.

6. The method for manufacturing a circuit board for a semiconductor package of claim 1, wherein the portion of the metal protecting layer and the conductive wires covered by the portion of the metal protecting layer are removed by laser, so as to electrically disconnect the electrically conductive pads from the conductive wires.

7. The method for manufacturing a circuit board for a semiconductor package of claim 1, wherein the metal protecting layer is made of a metal selected from a group consisting of lead, tin, silver, copper, gold, bismuth, antimony, zinc, nickel, zirconium, magnesium, indium, tellurium, and gallium, and an alloy thereof.

8. The method for manufacturing a circuit board for a semiconductor package of claim 1, wherein the metal protecting layer comprises multiple metallic layers, each of which is made of a metal selected from a group consisting of lead, tin, silver, copper, gold, bismuth, antimony, zinc, nickel, zirconium, magnesium, indium, tellurium, and gallium.
